(19) United States
(12) Patent Application Publication
(10) Pub. No.: US 2005/0092839 A1
(43) Pub. Date: May 5, 2005

(54) Method and apparatus for providing and processing active barcodes

(76) Inventor: Thomas K. Oram, Hudson, MA (US)

Correspondence Address: KENYON & KENYON, ONE BROADWAY, NEW YORK, NY, 10004, US

(21) Appl. No.: 10/698,152

(22) Filed: Oct. 31, 2003

(51) Int. Cl. G06K 15/00

(52) U.S. Cl. 235/462.13

(57) ABSTRACT

Embodiments of the present invention provide a platform-independent execution environment for executing embedded instructions. In one example, the instructions may be embedded in an active barcode format. In this embodiment a barcode encoded with an instruction may be read. A machine executable instruction may be generated based on the read barcode using a virtual machine. The machine executable instruction may be executed using the virtual machine.

### TECHNICAL FIELD

The present invention relates to processing computer executable instructions. In particular, embodiments of the present invention provide a method and apparatus for encoding and/or decoding embedded instructions.

### BACKGROUND OF THE INVENTION

There are many examples in business and industry where data is encoded in some form that can be read electronically. Examples may include barcodes or devices that store data. For example, barcodes may appear on paper documents, lottery tickets, discount coupons, grocery items, clothes, freight trains, postal mail, and anywhere else it is useful to identify the specific item or type of item.

A barcode or a data storage device may include data in a specific format appropriate for its use and may contain data that is decoded and understood by an electronic reader or another device that receives the data. In many cases, data formats and contents have been standardized. An example of standardized barcode format is universal product codes (UPC).

In some cases however, the device receiving information such as a bar code reader that may be coupled to a personal computer that may need to understand and/or process the data according to predefined rules. In the case of barcodes, 2 of 5 is a common barcode format used for encoding numeric information. However, when a device reading a barcode encoded with the code 2 of 5 format decodes the data, the device sees nothing but a series of digits. In order to process the series of digits, the device will be pre-programmed with a set on instructions that will process the information. For example, if such a device reads the digits “123456” from the barcode, a program running on the device and/or the personal computer will determine if the number is an identification of a truck or a lottery ticket. Thus, the program will determine the context of the information and/or how the information will be processed. Thus, a separate program may be needed for different information being read from a barcode.

Due to the variety of data formats and/or different methods or devices for storing and/or processing data, a common storage/processing format can be difficult to design and/or standardize.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of an apparatus in accordance with an embodiment of the present invention;

FIG. 2 illustrates an example of a lottery ticket that includes an embodiment of the present invention;

FIG. 2a is an interface that may facilitate play in a game of chance in accordance with an embodiment of the present invention;

FIG. 3 illustrates a block diagram of an apparatus in accordance with an embodiment of the present invention;

FIG. 4 is a flowchart of a method in accordance with an embodiment of the present invention;

FIG. 5 is a block diagram of a lottery ticket authentication system in accordance with an embodiment of the present invention; and

FIG. 6 is a flowchart of a method in accordance with an embodiment of the present invention.

### DETAILED DESCRIPTION

Embodiments of the present invention provide a platform-independent execution environment for executing embedded instructions. The instructions may be embedded in an object, in a variety of formats. The system of the present invention may convert the embedded instructions into machine language and execute the instructions. In one example, the instructions may be embedded in a barcode or any other format. Such barcodes may be referred to as active barcodes since they may contain executable instructions. If the instructions are embedded in a barcode, the barcode may include instructions and/or data that may be processed by the virtual machine, in accordance with embodiments of the present invention.

Embodiments of the present invention may provide a common format that may be used to generate and/or represent instructions and/or data that can be processed using, for example, a virtual machine. The instructions and/or data may be included on any object and may be used for inventory, tracking, and/or any other purpose desirable.

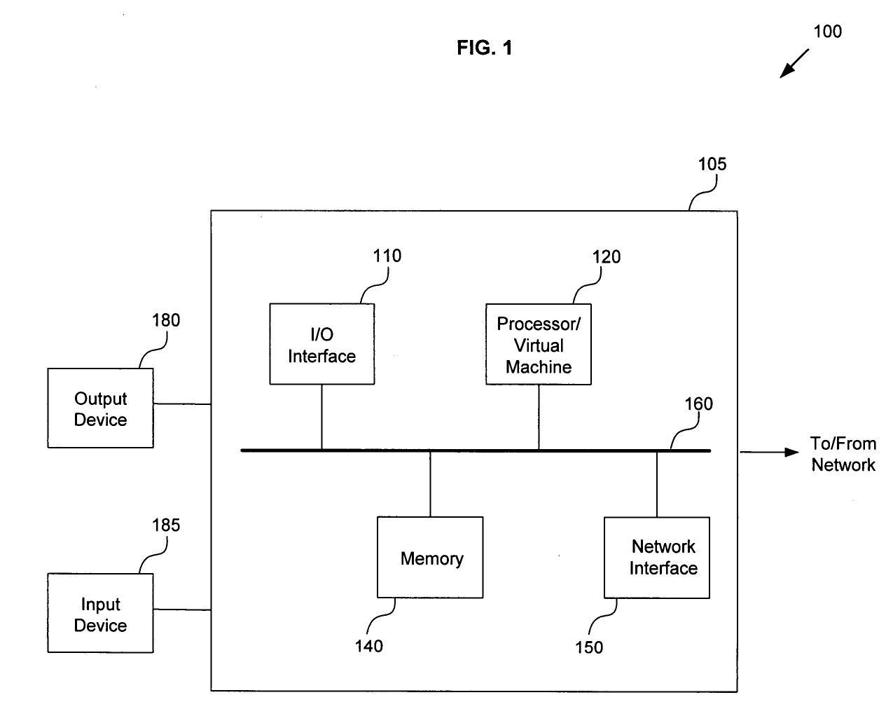

FIG. 1 is an exemplary block diagram of a system 100 in which embodiments of the present invention may find application. As shown in FIG. 1, the system 100 may include an embedded-information creation device 105 that may be coupled to an output device 180, input device 185 and/or a transit network. The output device 180 may be a display, a printer, a label maker, and/or any other device that produces an output. The input device 185 may be a keyboard, a mouse, a barcode or other type of scanner, a floppy drive, optical disk drive, transponder and/or any other type of input device.

In embodiments of the present invention, the embedded-information device 105 may be embodied in, for example, a personal computer, a barcode scanner, a personal digital assistance (PDA), a standalone device and/or any other type of device. The embedded instruction device 105 may include input/output (I/O) interface 110, processor/virtual machine 120, memory 140, and/or network interface 150. These devices may be coupled to and communicate with each other via bus 160. It is recognized that device 105 may include additional components that are omitted for convenience. The I/O interface 110 may provide the communications interface between the device 105, and the output device 180, input device 185 and/or any other I/O device. The network interface 150 may provide the communications interface with an external communications network. Memory 140 may be a system memory and/or a storage memory. Memory 140 may be any type of memory. Processor/virtual machine 120 may be any type of general-purpose processor and/or may be an application specific processor or the like.

In embodiments of the present invention, processor 120 may provide a virtual machine environment for device 105. A virtual machine may be a platform-independent execution environment that may convert instructions or code into machine language and executes them. Examples of virtual machines include Java Virtual Machine (JVM) (Java and JVM are trademarks or registered trademarks of Sun Microsystems, Inc. having a corporate office in Santa Clara, Calif.), interpreters and/or any other type of virtual machines. The virtual machine 120 may process embedded information to perform associated operations in accordance with embodiments of the present invention.

It is recognized that the virtual machine environment may be provided by a proprietary language that can be developed by one skilled in the art, in accordance with embodiments of the present invention. This proprietary operating environment that may run on any type of computer, processor and/or device.

In embodiments of the present invention, the device 105 may generate information that may be included on products such as clothes, electronics, or other consumer goods, and/or any other types of products. The embedded instructions may also be included on documents, lottery tickets, coupons, tags, labels and/or the like. Such information may include, for example, instructions and/or data that may be used for, for example, inventory management, security, tracking purposes, program loading, random number generation, and/or a myriad of other applications.

In an embodiment of the present invention, the embedded information may be included in a machine-readable medium such as a barcode (or active barcode) or other such medium. It is recognized that the embedded information such as instructions and/or data may be printed on a physical medium such as a document or another object. It is also recognized that the embedded information may be stored in an electronic format.

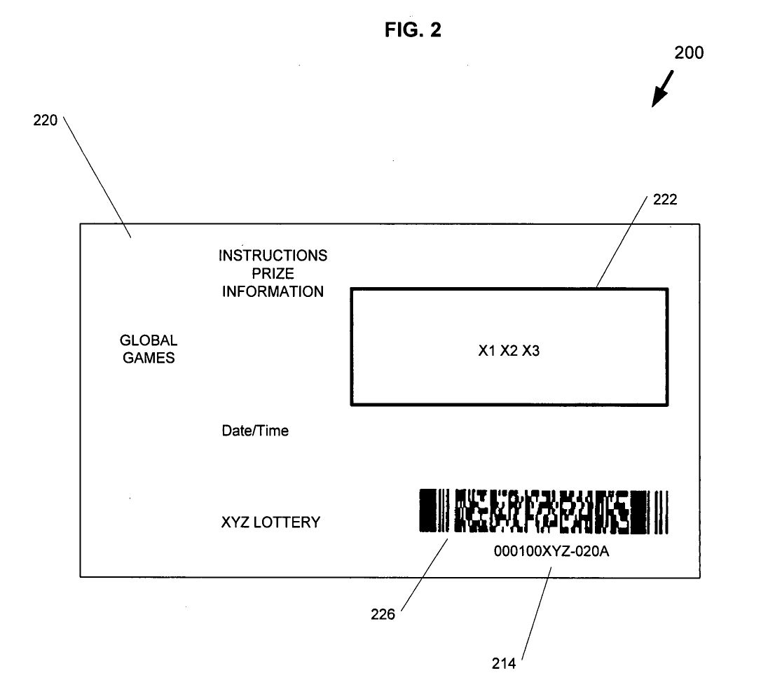

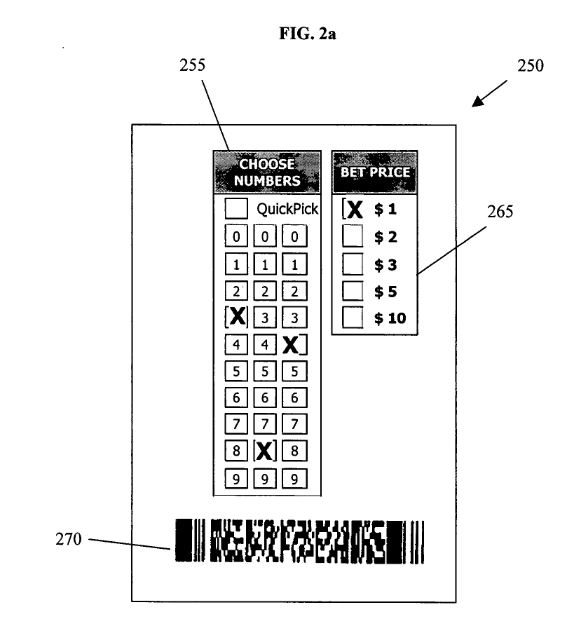

FIG. 2 illustrates an example of a lottery ticket 200 to which embodiments of the present invention may be applied. It is recognized that lottery ticket 200 is only given as an example and that embodiments of the present invention may be applied to an unlimited number and/or types of applications.

It is recognized that a lottery ticket 200 may be embodied in a paper document, a smart card, or any other physical and/or electronic embodiment. The example lottery ticket 200 illustrated in FIG. 2 may be located on a substrate, e.g., a printable substrate such as paper, card stock, plastic, or various laminates. Information may be found on both sides of the example lottery ticket. Lottery ticket 200 may be a future draw lottery ticket, an instant win lottery ticket, or any other type of ticket.

In an embodiment of the present invention, the lottery ticket 200 may include a non-play area 220 and a play area 222. The play area 222 may include game information such as numbers or other information that may be used to play a particular game. In this example, the non-play area 220 may include, for example, information not directly involved in the play of the game provided on the ticket. Located on the non-play area may be, for example, the name of the game, instructions for playing the game, prize information, date and time information, identification information, jurisdiction information, and/or any other information. It is recognized that the non-play and/or play areas are used herein for description purposes only and are not limiting or exclusive. Information shown on the ticket and/or described herein may be located anywhere on the ticket and is not limited to be located in a play or non-play area.

In an embodiment of the present invention, a machine-readable medium 226 may be included, for example, on the ticket 200. As used in this example, the machine-readable medium 226 may be represented in the form of a barcode or active barcode that may include embedded instructions and/or data, in accordance with embodiments of the present invention. If the machine readable medium 226 is a represented as a barcode, the barcode may be, for example, a stacked linear bar code, two-dimensional bar code, and/or any other type of barcode. The ticket 200 may include a ticket identifier or other type of information 214 that may also be include into the machine readable medium 226.

In embodiments of the present invention, the machine-readable medium 226 may be embedded with information such as program code or instructions and/or data. As stated above, the machine readable medium 226 may be included on a paper document, plastic substrate, a magnetic readable medium such as a floppy disk, a smart card, a tag, a label, an object or product and/or any other item or device. The embedded instructions may be processing instructions that may be used for tracking, inventory management, security, and/or any other purpose.

Referring again to FIG. 2, the device 105 may generate the machine readable medium 226 such as the barcode or other medium that may be embedded with data and/or instructions. In an embodiment of the present invention, an operator may write code in any given language using the input device 185, for example. The processor 120 may process the code to generate, for example, a barcode that represents the coded instructions and/or data. The output device 180 may generate an output that may represent the coded instructions and/or data in the form of, for example, a barcode, or any other format. For example, the coded instructions and or data may be included in a magnetic or optical medium, a device that transmits the coded instructions in the form of radio frequency signals, and/or in any other device and/or format. It is recognized that such instructions and/or data may be stored in any form desirable.

FIG. 2a shows an interface 250, which may be a game selection slip, that may be used to play a game of chance in accordance with embodiments of the present invention. Interface 250 may be used to select, for example, the type of one or more games to play, the numbers to play and/or the corresponding wager (e.g., amount to bet). The interface 250 may be embodied in a paper document, a smart card, in a web site, or any other physical and/or electronic medium. The interface 250 may be accessible via a PDA (personal digital assistance), a personal computer (PC), a television and/or any other device. For example, a user may access interface 250 over the Internet, e-mail and/or via regular mail. A player may play selected numbers using a periodic subscription such as an hourly, daily, weekly, monthly and/or any other type of subscription.

Interface 250 may include section 255, 265 and/or a section that includes a machine readable medium 270 such as the barcode and/or other medium that may be embedded with data and/or instructions, in accordance with embodiments of the present invention. As shown in FIG. 2a, for example, section 250 may be used by a player to select numbers and/or make other selections based on the game being play. For example, if the game is a future draw numbers game, section 255 may be used to select the numbers to be played. Although only three numbers are shown for selection in FIG. 2a, it is recognized that the game could include fewer or more numbers to be selected. For example, section 110 may include additional types of games such as two digit games, four digit games, five digit games, six digit games, seven digits, etc. Moreover, section 255 may include other characters or the like that may be selected by the user. Interface 250 may include other sections such as section 265 that may be used to select the wager amount (e.g., the bet price) and/or other sections that may include instructions and/or other information.

In embodiments of the present invention, as indicated above, the machine readable medium 270 such as a barcode may be embedded with data and/or instructions. As shown, barcode 270 may be a 2-D (two dimensional) barcode such as a PDF-417 barcode or any other barcode. Moreover, barcode 270 may be similar to the barcode as described with respect to barcode 226 or may be a different type of barcode.

In one example, the instructions encoded in the barcode 270 may include rules to validate and/or verify that the user has correctly completed the interface 250 to play the associated game. For example, if the interface 250 facilitates a pick-three game, the instructions encoded in the barcode 270 may instruct a terminal which may include a scanner to verify that three numbers were correctly selected. The terminal may be a gaming terminal or other machine or computer that can process gaming tickets. The terminal will read the barcode encoded with the instructions on the selection slip 250 via the scanner, process the instructions, and determine whether three numbers were selected. If three numbers were selected, then the terminal may validate the game election slip 250 and generate the requested lottery ticket in accordance with selections made by the user. If, however, only two numbers were selected for a pick-three game, the terminal may reject the selection slip 250 and request that the slip 250 be checked and the appropriate numbers be entered.

In embodiments of the present invention, the terminal may processes another selection slip having a barcode embedded with instructions. The embedded barcode may include instructions for processing the selection slip. For example, the user may wish to play a pick-six game. The embedded barcode such as barcode 250 may include the instructions so that the terminal can verify that the selection slip was completed correctly by the user. For example, the terminal may read the barcode and determine that the slip is for a pick six game. The terminal may process the instructions embedded in the barcode included on the slip and verify that all six numbers, in this example, were selected properly. In this case, the terminal does not need to be re-programmed to process a new type of game. The barcode embedded with instructions will instruct the terminal to verify and/or otherwise process the slip. For example, if a new game such as a pick five or pick seven game is introduced, gaming terminals do not need to be programmed to process the gaming slips for the new game. The barcode may include instructions that will instruct the terminal to process the selection slip for the new game. For example, the instructions may inform the terminal to generate pick five or pick seven game, to verify that the numbers were properly selected, and/or or to perform other checks related to processing the selection slip and generating a ticket. In accordance with embodiments of the present invention, programming of terminals to process new types of games can be avoided and savings of costs and/or other resources can be realized. This is possible because the instructions for validation, verification, and/or processing the games such as a game of chance may be included on the ticket embedded in a barcode.

Table 1 shown below provides an exemplary set of instructions or pseudo code that may be generated in accordance with embodiments of the present invention. In embodiments of the present invention, the instructions shown in Table 1 may be transformed into any virtual machine code and input to device 105 via input device 185.

TABLE 1

| | |
|---|---|
| 100 | Program Start; |
| 200 | Perform lotteryheadquarters.com/checkvalidity using |
| | IDNumber, Send IDNumber; |
| 300 | If OK, Send IDNumber and LocationID to |
| | monitor@lotteryheadquarters.com, else display error |
| | “Invalid”; |
| 400 | EndProgram |
| 500 | Begin Data |
| 600 | IDNumber = 1234-5678-9011 |
| 700 | Program End |

As shown in the exemplary instruction set listed in Table 1 above, line 100 may indicate or signal the start of the program. Line 200 may instruct that the web site “lotteryheadquarters.com” is contacted and a program called “check validity” may be executed. In embodiments of the present invention, the “check validity” program may, for example, use the “IDNumber” data to determine whether the IDNumber and, in this example, the corresponding lottery ticket is valid. For example, the “IDNumber” may be an identifier related to the lottery ticket or any other product or item it is associated with. The “check validity” program may verify whether the lottery ticket having that particular IDNumber exists and/or is valid. In other applications, the “check validity” program may verify that such an item exists and/or is offered for sale, for example. If the “IDNumber” is determined to be valid by the “check validity” program, the IDNumber and LocationID may be sent to “monitor@lotteryheadquarters.com,” as indicated in line 300.

In this example, the “IDNumber” may identify a number associated with a product, item or, in this case, a lottery ticket, that is read or received while the “LocationID” may identify the device reading or receiving the “IDNumber.” In this example, the “LocationID” may identify, for example, a store where the lottery ticket was purchased. In another example, the “LocationID” may identify the store where the product or object is present. As indicated in line 300, if the “IDNumber” is not valid, the program may display an error message indicating that the number is “Invalid” or the like. The data which in this case may be the IDNumber and/or other data may be located in lines 500 to 700, where line 500 may signal the beginning of the data, which may begin in line 600, while line 700 may signal the end of the data. Of course, additional data may be included in embodiments of the present invention.

In embodiments of the present invention, the information such as the “IDNumber” and/or the “LocationID” may be received at the location specified by the address “monitor@lotteryheadquarters.com.” The information may be processed and may be used for tracking, inventory, security, and/or any other purposes, for example. A confirmation signal may be sent back to the device that provided the information, if the transmission and/or reception were successful. Otherwise, a request may be sent to re-send the data.

It is recognized that the instructions provided in Table 1 are given by of example and/or for illustration purposes only and should not be construed to be limiting in any way. It is recognized that a variety of instructions may be written in any number of different ways. As indicated above, the instructions as shown in Table 1 are represented in pseudo code or in an artificial language that could be written in any computer language desirable. For example, the instructions may be written in JAVA® or any other language. It is recognized that the instructions may be written in a proprietary or new language for the purposes of the invention. In embodiments of the present invention, the instructions may be compiled and may run on a virtual machine or other runtime environments that can operate on a variety of operating systems.

In embodiments of the present invention, as indicated above, the instructions may be input to device 105 which may process the instructions. For example, the processor 120 may convert the instructions into a compact format that can be included on, for example, lottery tickets, clothing tags, automobiles, mail or packages and/or a myriad of other objects and/or products. In embodiments of the present invention, the instructions may be converted in a barcode format such as a 2-D barcode. In other embodiments of the present invention, the instruction set may be provided as code that can be stored in an electronic device in any format, and/or the instructions may be provided in any other format that can be embodied in any suitable medium. It will be appreciated that the instructions may be stored on magnetic strips, smart cards, or the like.

In embodiments of the present invention, the output device 180 may generate the instructions in any suitable form. For example, the output device 180 may generate a barcode embedded with the instruction set such as the instruction set shown in Table 1. In this case, the barcode may be placed on or otherwise associated with the item, product, etc. For example, the output device 180 may generate the barcode 226 embedded with instructions that may be printed on ticket 200. In embodiments of the present invention, the instructions may be encrypted and/or compressed before the instructions are encoded into a barcode or any other format, for example.

As shown, barcode 226 may be a 2-D (two dimensional) barcode such as a PDF-417 barcode or any other barcode. In embodiments of the present invention, the barcode embedded with instructions may be in any suitable format such as one dimensional or two dimensional barcode format, and/or any other format. For example, the barcode formats may be a PDF-417, MaxiCode, Data Matrix, code 128, code 39, l2 of 5, UPC (Universal Product Code) and its European and Japanese counterparts, EAN and JAN, and Postnet, or any other format and/or combination thereof. It is recognized that the any barcode that can be embedded with instructions and/or data may be used in accordance with embodiments of the present invention.

In another embodiment of the present invention, the output device 180 and/or the network interface 150 may output the instructions in another format. For example, the instructions may be output in a format that can be sent to an electronic device that may store the instructions in the appropriate format. For example, such an electronic device may employ radio frequency identification (RFID) technology to transmit and/or retrieve data. RFID uses electromagnetic or electrostatic coupling in the RF portion of the electromagnetic spectrum to transmit signals. An RFID enabled device may include, for example, an antenna and a transceiver, which may read the radio frequency and transfer the information to a processing device. The antenna and/or transceiver may also be used to receive the information.

The data and/or instructions may be included in a transponder which may be, for example, an integrated circuit containing the RF circuitry. The transponder may include a memory and may transmit the data and/or instructions to the transceiver. An RFID tag may be stored and may include the embedded instructions and/or data, in accordance with embodiments of the present invention. The instructions may be sent to such a device via a wired and/or wireless connection. In the case of RFID technology, the instructions may be read by a wireless connection. In embodiments of the present invention, information may be retrieved without the need for line-of-sight reading that bar coding depends on. Also, RFID scanning can be done at greater distances than bar code scanning.

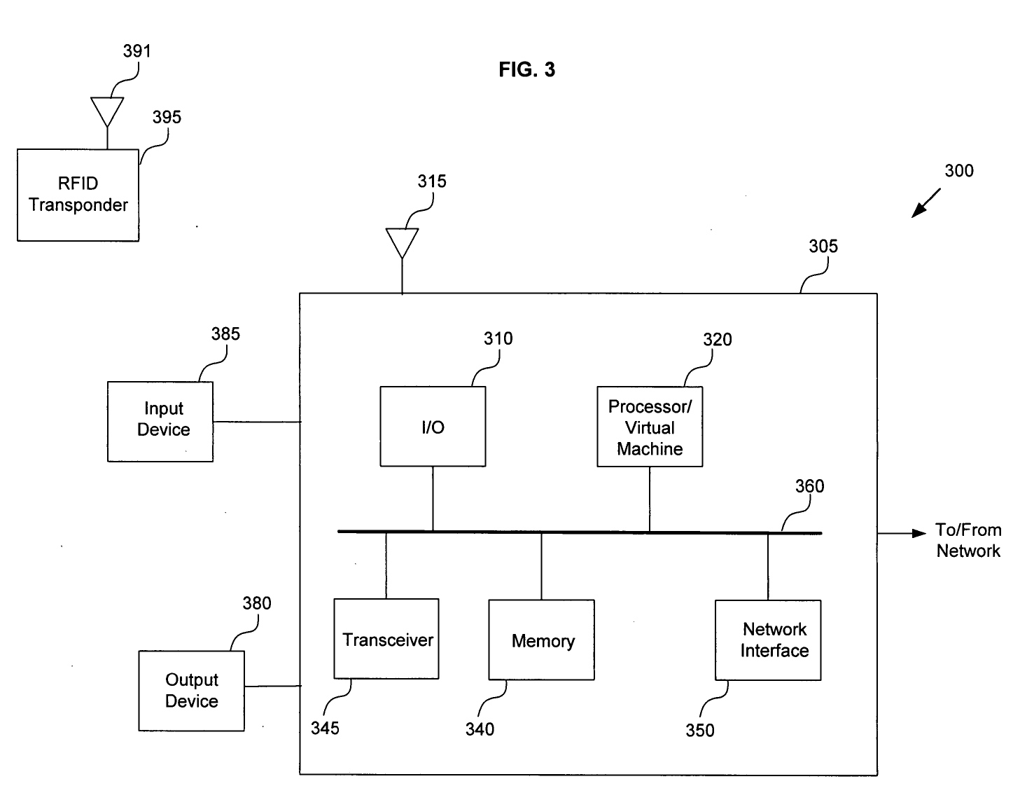

FIG. 3 is an exemplary block diagram of a system 300 in which embodiments of the present invention may find application. System 300 may be used to read or receive the embedded instructions, and may process the instructions using, for example, a virtual machine. As shown in FIG. 3, the system 300 may include an embedded-information processing device 305 that may be coupled to an input device 385 and/or a transit network. The system may include an output device 380 that may be a display, a printer, a label maker, a wireless transmitter (e.g., RF transmitter) and/or any other device that produces an output. The input device 385 may be scanner such as a barcode scanner or other type of scanner, a keyboard, a mouse, a floppy drive, optical disk drive and/or any other type of input device. In embodiments of the present invention, the system 300 may include an antenna 315 that may be used to transmit and/or receive RF and/or other type of signals.

It is recognized that the device to read the barcode such as barcodes 270 and/or 226 embedded with instructions may be any type of scanner. For example, such a scanner or reading device may be able to read 2-D barcodes or similar barcodes.

In embodiments of the present invention, the embedded-information processing device 305 may be embodied in, for example, a personal computer, a barcode scanner, a personal digital assistance (PDA), and/or any other type of device. It is recognized that the input device 385, output device 380, processing device 305 and/or the antenna 315 may all be incorporated into a single device or may be in separate devices.

The processing device 305 may include input/output (I/O) interface 310, a transceiver 315, a processor/virtual machine 320, memory 340, and/or network interface 350. These devices may be coupled to and/or communicate with each other via bus 360. It is recognized that device 305 may include additional components. The I/O interface 310 may provide the communications interface between the device 305, and the output device 380, input device 385 and/or any other I/O device. The network interface 350 may provide the communications interface with an external communications network. Transceiver 345 may be a transmitter/receiver that may transmit and/or receive information via the antenna 315, for example. Memory 340 may be a system memory and/or a storage memory. Memory 340 may be any type of memory. Processor/virtual machine 320 may be any type of general-purpose processor and/or may be an application specific processor or the like.

In embodiments of the present invention, the input device 380 and/or transceiver 345 may receive an external input. For example, the input device 380 may be a barcode scanner that reads a barcode embedded with instructions, for example. The information may be read and transmitted to the virtual machine 320. The virtual machine 320 may generate a series of bits that represent the embedded-instructions based on the read information. The series of bits may be compiled into a grouped set of bits that represent the instruction embedded in the barcode, for example. The virtual machine 320 may process the compiled instructions, in accordance with embodiments of the present invention.

For example, an input device 380 such as a barcode scanner may read a barcode embedded with instructions as shown in Table 1, above. The virtual machine 320 may process the barcode and compile the instruction set for processing. The virtual machine 320 may run the instructions perform the various tasks as encoded in the barcode, for example. Thus, once the virtual machine recognizes that a program is to be executed, it may process the first line of executable code. In the case of exemplary instruction set shown in Table 1, the device 305 may send a request to execute the “checkvalidity” program at the web site “lotteryheadquarters.com” and may send the IDNumber along with the request. The device 305 may communicate with, for example, the Internet via the network interface 350. If the device 305 receives a confirmation from the web site that the IDNumber is for example, valid, then the virtual machine 320 may execute the next line of the code, otherwise the device may terminate the program.

If the IDNumber is determined to be valid, the device 305 may send the IDNumber and LocationID to monitor@lotteryheadquarters.com. After the IDNumber and LocationID are sent, the program may terminate.

In embodiments of the present invention, the site receiving the information such as the IDNumber and/or the LocationID may process the information for tracking, security, inventory and/or other purposes. For example, the site receiving the lottery ID number may run appropriate checks to validate the lottery ticket. In some cases, the processing device 305 may receive a notification that the information was received, has been processed and/or has been validated. Such a notification may be presented on the output device 380.

As stated above, although the discussion with respect to system 300 relates to barcodes, it is recognized that embodiments of the present invention may be used employed using other technologies. For example, RFID technology may be used to store, transmit, and/or receive instructions and/or data. For example, the exemplary instructions as shown in Table 1 may be stored in an RFID enabled device, as described above. Such a device may store instructions as described herein and may be coupled to an item, product, etc. The RFID enabled device may store instructions in any suitable form.

In an embodiment of the present invention, the device 305 may send a signal or trigger via the antenna 315 to the RFID enabled device. An RFID transponder or tag 395 may receive the trigger via antenna 391. In response to the trigger, the RFID enabled device including the transponder 395 may transmit the stored instruction set such as instruction set shown in Table 1 to the requesting device 305. The instruction set may be stored in a memory (omitted) or the like. The device 305 may receive the instructions and may process them as described above. It is recognized that the transponder 395, antenna 391, memory and/or any other component may be incorporated into a lottery ticket, a coupon, tag, label, a consumer good or the like.

It is recognized that embodiments of the invention may include, for example, other components such as processors, computer readable memories, data ports or other interfaces, network ports or other interfaces, data buses and/or other hardware and/or software components (all not shown). The data ports or other interfaces may permit the various devices to communicate with other devices and/or with the transit network. The data buses may connect the processor, the computer readable memory, the data port or other interface and/or the network port or other interface and may permit communications between the various components in embodiments of the invention.

The transit network that devices 105 and/or 305 may be coupled to may be, for example, a communications network that may include, for example, a public switched telephone network (PSTN), an Integrated Services Digital Network (ISDN), a cellular network, a digital mobile network, a Personal Communication Systems (PCS) network, an Internet, an intranet, a signaling system 7 (SS7) network, a local area network (LAN), a satellite network, an advance intelligent network (AIN), any suitable digital or analog network, a broadband network such as a cable network, any other suitable national and/or international communications network or any suitable combination thereof.

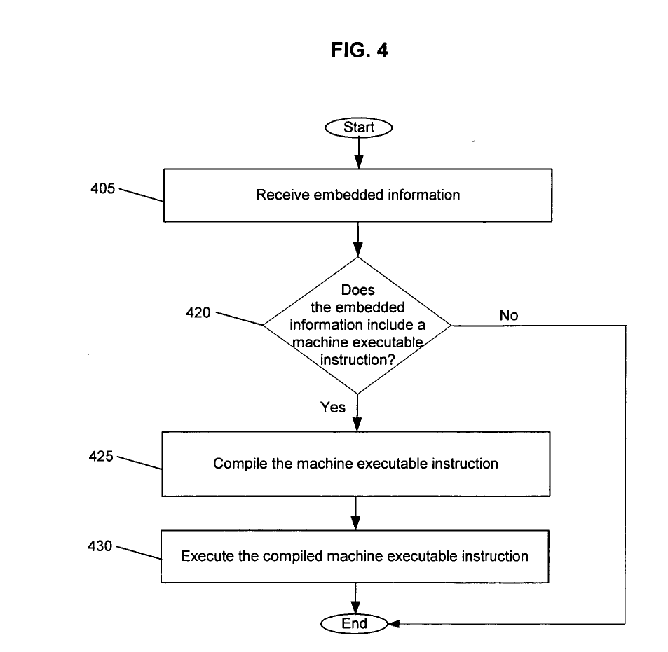

FIG. 4 is a flowchart illustrating a method in accordance with embodiments of the present invention. As shown in box 405, a device such as an embedded-information-processing device 305 may receive embedded information. The information may be embedded in a barcode, a RF signal and/or any other format. The information may be included on a lottery ticket or any other object or product. The device may determine whether the embedded information includes a machine executable instruction, as shown in box 420. If it does, the device may compile the machine executable instruction, as shown in box 425. If it does not, the process may end. The compiled instructions may be executed by the virtual machine, as shown in box 430.

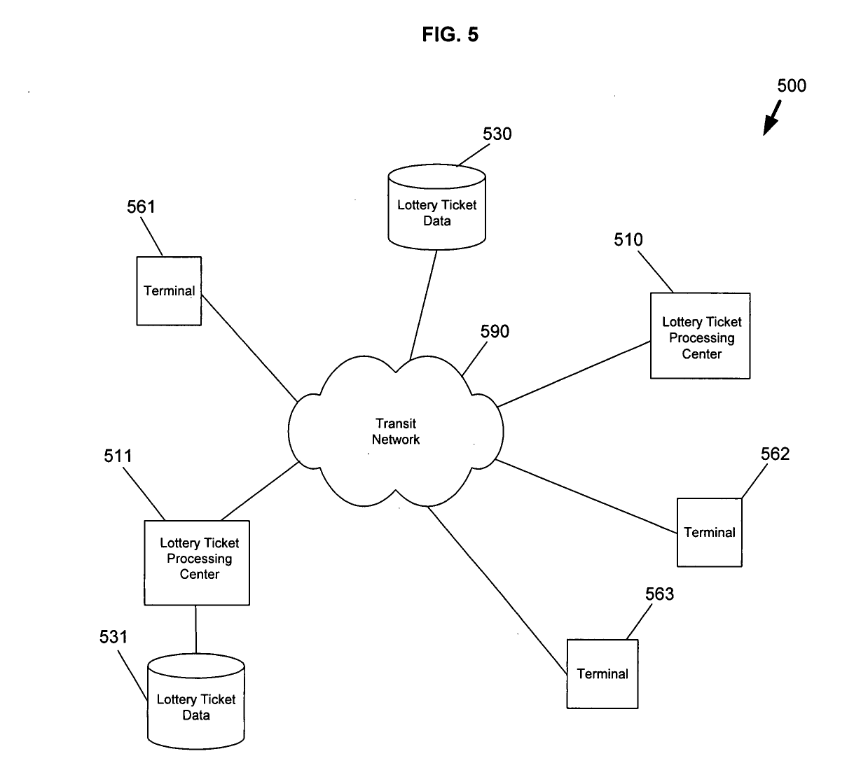

FIG. 5 is an exemplary block diagram of gaming system 500 in which embodiments of the present invention may find application. As shown in FIG. 5, a plurality of terminals, for example, terminals 561-563 may be coupled to a transit network 590. Terminals 561-563 may be gaming terminals and/or a computer or similar device that can process gaming information and/or generate lottery tickets, in accordance with embodiments of the present invention. Terminals 561-563 may include suitable hardware and/or software to, for example, process barcodes that may be embedded with instructions, in accordance with embodiments of the present invention. For example, terminals 561-563 may include virtual machine, an interpreter, and/or any other suitable software and/or hardware that can process instructions that may be embedded in a barcode. It is recognized that the terminals 561-563 may include a scanner and/or other device that can read a barcode embedded with instructions and transmit the read information to a processor in the terminal 561-563, where the instruction may be processed.

In embodiments of the invention, terminals 561-563 may be coupled to an RFID transmitter and/or receiver that can communicate with an RFID transponder and/or tag that may be incorporated within a lottery ticket embedded with a paper ticket, a smart card, etc. A memory included on the ticket may store instructions and/or data that may be transmitted to the transmitter/receiver coupled to the terminals 561-563 via the transponder. A processor in the terminals 561-563 may process the instructions and/or data as appropriate.

The terminals 561-563 may be located at lottery ticket vendors, stores, or other entities that may process, sell and/or redeem tickets for games of chance. The system may further include lottery ticket verification/processing centers 510-511 and/or lottery ticket databases 530-531 containing data related to lottery tickets. Data included in databases 530-531 may be authentication data, rules for playing the games of chance, and/or any other information associated with the games of chance. It is recognized that additional clients, databases, authentication centers, servers and/or other components or devices may be included in the lottery ticket authentication system shown.

Transit network 590 may be a communications network that may include, for example, a public switched telephone network (PSTN), an Integrated Services Digital Network (ISDN), a cellular network, a digital mobile network, a Personal Communication Systems (PCS) network, an Internet, an intranet, a signaling system 7 (SS7) network, a local area network (LAN), a satellite network, an advance intelligent network (AIN), any suitable digital or analog network, a broadband network such as a cable network, any other suitable national and/or international communications network or any suitable combination thereof. It is recognized that embodiments of the present invention may utilize magnetic or optical media (e.g., hard drives, tapes, disks, etc.) to store and/or transmit data. A retailer or client may process a transaction offline and may later send the information via the network 590, disk, tape, or other transmission media to processing centers 510-511 for processing.

In embodiments of the present invention, instructions embedded in barcodes and/or transmitted via an RFID tag may be processed. For example, if the bar code is included on a selection slip or other interface for playing a game of chance, the instructions embedded in the barcode may include rules for playing the particular game of chance, as described above. In this way the rules and/or instructions related to the game may be included on the ticket and may be used to verify that the user or player, for example, picked the correct number of digits. For example, if the game played is a pick four type of game, the instructions included in the barcode may notify the terminal such as terminal 562 to check that the player selected only four numbers on the selection slip. In this manner, if a new type of game is introduced, the rules for the game may be included in the form of instructions embedded a barcode on the game ticket, smart card, etc. Thus, terminal processing the barcode can read the rules from the selection slip or other interface and process the rules to verify that the rules have been complied with. Accordingly, the terminals 561-563 may not need to be programmed and re-programmed every time a new game of chance is introduced. The rules, etc. for the game may be included in the barcodes on the ticket.

It is recognized that the instruction embedded in the barcode can be processed locally at the terminals 561-563 and/or may be processed the at the processing centers 510-511 via the network 590. For example, the barcode embedded with the instruction may be read at the terminal 562, the embedded instruction may be processed at the terminal 562. In the event validation and/or other processing is required, the processing centers such as centers 510 and/or 511 may be contacted for validation. Moreover, data from databases 530 and/or 531 may be retrieved and/or processed by the processing centers 510-511 to, for example, validate a lottery ticket being redeemed as valid.

As indicated above, terminals 561-563 may include for example scanners such as barcode scanners or other types of input devices such as keyboards that may be used to enter and/or read data from the items that may be used to input information from the lottery ticket.

In embodiments of the present invention, lottery ticket processing centers 510-511 may include suitable hardware such as computers, servers and/or software that can process the instructions embedded in the barcodes. The databases 530-531 may include one or more lottery ticket identifiers or the like that may identify the lottery ticket and may be used to authenticate or validate the lottery ticket.

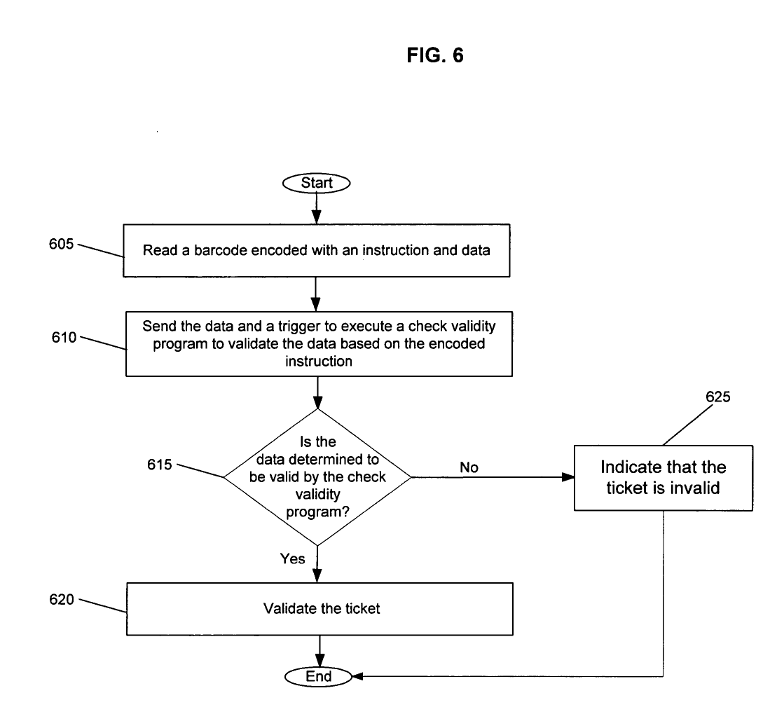

FIG. 6 is a flowchart illustrating a method in accordance with embodiments of the present invention. As shown in box 605, a barcode encoded with an instruction and data may be read. The barcode may be included on a ticket associated with a game of chance. The data and a trigger may be sent to execute a check validity program to validate the data based on the encoded instruction, as shown in box 610. If the data is determined to be valid by the check validity program, validate the ticket, as shown in boxes 615 and 620. If the data is determined to be invalid by the check validity program, indicate that the ticket is invalid, as shown in boxes 615 and 625.

Embodiments of the present invention a barcode and/or a RFID tag embedded with include machine executable instructions. The barcodes and/or RFID tag embedded with instructions and/or data can read by a device coupled to a machine which can interpret and/or process the instructions to perform the task as specified by the instructions. The barcode and/or the RFID tag may further include a data portion along with the instructions. The machine may execute operations on the data portion based on the instructions. In accordance with embodiments of the present invention, generic machines are able to process the instructions embedded in the barcode and/or RFID tag without being programmed for the specific task. Thus, considerable costs and/or resources can be saved.

Embodiments of the present invention can be applied to a myriad of different applications. For example, a device may read a barcode and/or a RFID tag embedded with instructions and/or data, in accordance with embodiments of the present invention, on a passing freight train, truck, automobile, ship, or the like. The device may execute the program or instructions embedded in the barcode of RFID tag, which may direct the device to send an e-mail message to an entity or individual. The e-mail message may include such information as the time, location, etc. the reading occurred so that, for example, the train, truck, ship, etc. can be tracked and/or the arrival time at a destination can be estimated.

In another example, a device could read a barcode and/or a RFID tag embedded with instructions and/or data on a piece of clothing and execute the instructions embedded therein. The instructions may generate a random number and a discount may be given to the customer based on the random number generated. In another example, a manufacturer's coupon may include a barcode and/or a RFID tag embedded with instructions and/or data. The instructions may be specified by manufactures and may give flexibility on how the various coupons can be used. For example, the instructions may indicate the dates and/or times when the coupons may be activated, what discounts may be given, increase discounts when multiple items are purchased, etc. The instructions, information and/or the codes to process the instructions or information may be included in a barcode and/or a RFID tag. Accordingly, there would be no need to reprogram devices for new promotions, etc.

In another example, in accordance with embodiments of the present invention, mail, packages, other products, etc. may include a barcode and/or a RFID tag embedded with instructions and/or data that may be read and direct the processing equipment to sort the mail, packages, etc. in a certain way. For example, the barcode and/or RFID tag may contain a program or instructions to a direct an package or envelope to an overnight pouch, regular mail pouch, etc. To change and/or add sorting methods, only the barcodes and/or RFID tags need to be changed. There is no need to re-program devices and/or computers. Similarly, as inventory moves through various stages of productions, warehousing and/or distribution, a barcode and/or a RFID tag embedded with instructions and/or data included on the inventory could include a program to, for example, send a message to indicate its status through the various processes.

In yet another example, in accordance with an embodiment of the present invention, a bill may include a barcode and/or a RFID tag embedded with instructions and/or data. The instructions or program may specify how funds can be transferred to the billing company to pay the bill. Thus a customer maybe able to present the bill and/or payment to a retail location. The barcode and/or a RFID tag embedded with instructions and/or data may be read from the bill and may specify how to automatically transfer funds to the billing company's account. The retailer may transfer some percentage of the bill into the retailer's account in the form of a fee or a commission.

In embodiments of the present invention, a barcode and/or a RFID tag or transponder embedded with instructions and/or data may be included on a car, truck, motorcycle, other vehicle or the like. In one example, the barcode or RFID tag may be read every time the car, truck, etc. passes a tollbooth. The embedded instructions and/or data may direct the reading device to debit the driver's account for the amount of the toll. Thus, any tollbooth in the country could automatically process the toll from the drivers account without requiring specialized hardware and/or software both for the driver and/or for the tool both.

Embodiments of the present invention can be a included in, for example, merchandise or clothing tags that may include specialized instructions associated with the product and processed accordingly. Proximity security cards that are used to gain access to a building may also include specialized instructions as well as proximity cards that serve as financial instruments, for example, to purchase gasoline at pumps and/or to purchase other products.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A method for validating a ticket associated with a game of chance, comprising:
reading a barcode encoded with an instruction and data, wherein the barcode is included on the ticket;
based on the encoded instruction, sending the data and a trigger to execute a check validity program to validate the data; and
if the data is determined to be valid by the check validity program, validating the ticket.

2. The method of claim 1, wherein the data is an identifier associated with the ticket.

3. The method of claim 1, further comprises:
processing the data using the executed check validity program to determine if the data is valid.

4. The method of claim 1, further comprises:
based on the encoded instruction, connecting to a remote terminal via a communications network, wherein the check validity program is executed at the remote terminal.

5. The method of claim 1, further comprises:
based on the encoded instruction, connecting to a web site via a communications network, wherein the check validity program is executed at the web site.

6. The method of claim 5, wherein the communications network includes an Internet.

7. The method of claim 1, further comprises:
if the data is determined to be invalid by the check validity program, indicating that the ticket is invalid.

8. The method of claim 1, wherein the barcode is a two-dimensional barcode.

9. The method of claim 8, wherein the two-dimensional barcode is in a PDF-417 format.

10. A system for validating a ticket associated with a game of chance, the system comprising:
a local terminal;
a device coupled to the terminal to read a barcode encoded with an instruction and data, wherein the barcode is included on the ticket;
a remote terminal to receive the data and a trigger from the local terminal based on the encoded instruction, wherein the trigger is to execute a check validity program at the remote terminal and if the data is determined to be valid by the check validity program, the remote terminal to send a validation signal to the local terminal and in response to the validation signal, the local terminal to validate the ticket.

11. The system of claim 10, wherein the data is an identifier associated with the ticket.

12. The system of claim 10, further comprises:
a communications network, wherein the local terminal is coupled to the remote terminal via the communications network.

13. The system of claim 12, wherein the communications network includes an Internet.

14. The system of claim 10, wherein the remote terminal is to process the data using the executed check validity program to determine if the data is valid.

15. The system of claim 10, wherein the device coupled to the terminal to read the barcode encoded with an instruction is a barcode scanner.

16. The system of claim 10, wherein the barcode is a two-dimensional barcode.

17. The system of claim 16, wherein the two-dimensional barcode is in a PDF-417 format.

18. The system of claim 17, wherein the device coupled to the terminal to read the barcode encoded with an instruction is a barcode scanner that can read two-dimensional barcodes.

19. A method for verifying that a selection slip associated with a game of chance has been completed correctly, comprising:
reading a barcode encoded with an instruction, wherein the barcode is included on the selection slip;
processing the instruction encoded in the barcode;
determining if the selection slip was completed in accordance with the processed instruction encoded in the barcode; and
verifying that the selection slip was completed correctly if it is determined that the selection slip was completed in accordance with the processed instructions encoded in the barcode.

20. The method of claim 19, further comprises:
generating a machine executable instruction based on the read barcode using a virtual machine; and
executing the machine executable instruction using the virtual machine.

21. The method of claim 19, wherein the operation of determining if the selection slip was completed in accordance with the processed instruction encoded in the barcode:
determining a number of digits that need to be selected to play the game of chance based on the processed instruction encoded in the barcode;
determining a number of digits played on the selection slip;
if the number of digits that need to be selected match the number of digits played on the selection slip, indicating that the selection slip has been completed in accordance with the processed instruction encoded in the barcode.

22. The method of claim 21, further comprises:
if the number of digits that need to be selected do not match the number of digits played on the selection slip, indicating that the selection slip has not been completed in accordance with the processed instruction encoded in the barcode.

23. The method of claim 22, further comprises:
indicating that the selection is invalid if the number of digits that need to be selected do not match the number of digits played on the selection slip.

24. An apparatus for verifying that a selection slip associated with a game of chance has been completed correctly, comprising:
a device to read a barcode encoded with an instruction, wherein the barcode is included on the selection slip; and
a terminal coupled to the device, the terminal to:
process the instruction encoded in the barcode,
determine if the selection slip was completed in accordance with the processed instruction encoded in the barcode, and
verify that the selection slip has been completed correctly if it is determined that the selection slip was completed in accordance with the processed instructions encoded in the barcode.

25. The system of claim 24, wherein the terminal is to further:
generate a machine executable instruction based on the read barcode using a virtual machine; and
execute the machine executable instruction using the virtual machine.

26. The system of claim 24, wherein the terminal is to further:
determine a number of digits that need to be selected to play the game of chance based on the processed instruction encoded in the barcode;
determine a number of digits played on the selection slip;
if the number of digits that need to be selected match the number of digits played on the selection slip, indicate that the selection slip has been completed in accordance with the processed instruction encoded in the barcode.

27. The system of claim 26, wherein the terminal is to further:
indicate that the selection slip has not been completed in accordance with the processed instruction encoded in the barcode, if the number of digits that need to be selected do not match the number of digits played on the selection slip.

28. The system of claim 27, wherein the terminal is to further:
indicate that the selection is invalid if the number of digits that need to be selected do not match the number of digits played on the selection slip.

29. The system of claim 24, wherein the barcode is a two-dimensional barcode.

30. The system of claim 29, wherein the two-dimensional barcode is in a PDF-417 format.

31. A method comprising:
reading a barcode encoded with an instruction;
generating a machine executable instruction based on the read barcode using a virtual machine; and
executing the machine executable instruction using the virtual machine.

32. The method of claim 31, further comprises:
reading a data portion from the barcode;
executing operations on the data portion, wherein the operations are specified by the machine executable instructions.

33. The method of claim 31, wherein the virtual machine is a Java virtual machine.

34. The method of claim 31, wherein the barcode is a two-dimensional barcode.

35. The method of claim 34, wherein the two-dimensional barcode is in a PDF-417 format.

36. A method of encoding instructions comprising:
receiving an instruction;
encoding the instruction into a barcode; and
outputting the barcode.

37. The method of claim 36, further comprises:
compressing the instruction.

38. The method of claim 37, further comprises:
encoding the compressed instruction into the barcode.

39. The method of claim 36, further comprises:
encrypting the instruction.

40. The method of claim 39, further comprises:
encoding the encrypted instruction into the barcode.

41. The method of claim 36, wherein outputting the barcode comprises:
printing the generated barcode on an object.

42. The method of claim 36, further comprising:
transmitting the encoded instruction to a receiving device via a wireless interface.

43. The method of claim 36, further comprising:
transmitting the encoded instruction to a receiving device via a radio frequency enabled interface.

44. The method of claim 36, wherein the barcode is a two-dimensional barcode.

45. The method of claim 44, wherein the two-dimensional barcode is in a PDF-417 format.

46. Apparatus comprising:
an input interface to read a barcode encoded with an instruction;
a processor to generate a machine executable instruction based on the read barcode and to execute the machine executable instruction.

47. The apparatus of claim 46, further comprising:
a virtual machine that operates on the processor to execute the machine executable instruction.

48. The apparatus of claim 47, wherein the virtual machine is a Java virtual machine.

49. The apparatus of claim 48, wherein the instruction is a Java executable.

50. The apparatus of claim 46, wherein the input interface is a barcode scanning device.

51. An apparatus comprising:
a processor unit to receive an instruction and to generate a barcode encoding the instruction.

52. The apparatus of claim 51, further comprises:
an output interface to output the barcode.

53. The apparatus of claim 52, wherein the output interface is a printer.

54. The apparatus of claim 51, wherein the barcode is a two-dimensional barcode.

55. The apparatus of claim 54, wherein the two-dimensional barcode is in a PDF-417 format.

56. A machine-readable medium having stored thereon a plurality of executable instructions to be executed by a processor to implement a method for executing instructions, the method comprising:
reading barcode encoded with an instruction;
generating a machine executable instruction based on the read barcode; and
executing the machine executable instruction using a virtual machine.

57. A barcode embedded with machine executable instructions to be executed by a virtual machine.

58. The barcode of claim 57, wherein the machine executable instructions are Java instructions.

59. The barcode of claim 57, wherein the virtual machine is a Java virtual machine.

60. The barcode of claim 57, wherein the barcode is a two-dimensional barcode.

61. The barcode of claim 60, wherein the two-dimensional barcode is in a PDF-417 format.

62. A method comprising:
reading information included in a barcode;
generating a series of bits based on the read information by a virtual machine;
compiling the bits into a grouped set of bits that represent a machine executable instruction by the virtual machine; and
processing the grouped set of bits by the virtual machine.

63. A method comprising:
reading embedded information, wherein the embedded information includes an instruction;
generating a series of bits based on the read information;
compiling the bits into a grouped set of bits that represent the instruction; and
inputting the grouped set of bits into a virtual machine for execution.

64. The method of claim 63, wherein the instructions are embedded in a barcode.

65. The method of claim 63, wherein the embedded information is read via a radio frequency identification enabled device.

66. The method of claim 63, wherein the embedded information is read via a wireless device.

67. A method comprising:
reading an radio frequency identification tag encoded with an instruction;
generating a machine executable instruction based on the read radio frequency identification tag using a virtual machine; and
executing the machine executable instruction using the virtual machine.

68. The method of claim 67, further comprises:
reading a data portion included in the radio frequency identification tag;
executing operations on the dat7a portion, wherein the operations are specified by the machine executable instructions.

69. A method for validating a ticket associated with a game of chance, comprising:
reading a barcode encoded with an instruction and data, wherein the barcode is included on the ticket;
processing the instruction encoded in the barcode; and
validating the ticket if the instruction is processed successfully.

70. The method of claim 69, wherein the barcode is a two-dimensional barcode.

71. The method of claim 70, wherein the two-dimensional barcode is in a PDF-417 barcode format.
